(19) United States
(12) Patent Application Publication
(10) Pub. No.: US 2008/0237498 A1
(43) Pub. Date: Oct. 2, 2008

(54) High-efficiency, low-debris short-wavelength light sources

(76) Inventor: Joseph J. MacFarlane, Verona, WI (US)

Correspondence Address: SMITH LAW OFFICE, 440 SCIENCE DR., SUITE 302, MADISON, WI, 53711, US

(21) Appl. No.: 12/009,994

(22) Filed: Jan. 23, 2008

Related U.S. Application Data
(60) Provisional application No. 60/897,955, filed on Jan. 29, 2007.

(51) Int. Cl. G21G 4/00

(52) U.S. Cl. 250/493.1

(57) ABSTRACT

This invention relates generally to short-wavelength radiation from laser-produced and discharged produced plasmas, and more particularly to efficient systems and methods for obtaining short-wavelength radiation.

This application claims priority on Application No. 60/897,955 filed Jan. 29, 2007, the disclosure of which is incorporated by reference herein.

The U.S. Government has a paid-up license in this invention and the right in limited circumstances to require the patent owner to license others on reasonable terms as provided for by the terms of Grant No. OII-0610632 awarded by NSF Phase I SBIR Grant.

### BACKGROUND OF THE INVENTION

This invention relates generally to short-wavelength radiation from laser-produced and discharged produced plasmas, and more particularly to efficient systems and methods for obtaining short-wavelength radiation.

Short-wavelength (including x-ray or extreme ultraviolet) radiation can be used as an exposure light source in lithography, medical research, and other commercial applications. In the lithography application, extreme ultraviolet (“EUV”) radiation at wavelengths near 13.5 nm can be used in manufacturing semiconductors, for example.

Short-wavelength radiation can be generated using a source material that is heated to very high temperatures that may reach 10⁵ to 10⁶ degrees Kelvin. A source material may include a primary radiating material, such as tin (Sn) that is embedded in low atomic number gases or water droplets. The primary radiating material is considered the “hot portion” of the source material that emits radiation. Primary radiating material was described as being tin (Sn) or tin hydride (SnH₄) in U.S. Pat. No. 6,984,941 to Hiramoto, for example. When the primary radiating material is heated to very high temperatures, it creates hot plasma and radiates light in efficient and narrow wavelength bands, thereby providing light sources useful in the above-described applications.

The very high temperatures are achieved by laser beams or by a discharge process in which a high current is allowed to flow in a radiating material to generate heat. A combination of both laser and discharge process can also be used to heat the source material. Regardless of the way in which heat is generated, the short-wavelength light emitted from the source material is reflected and focused toward a suitable end-use or “tool” using mirrors in an optics component of the system.

Heating source material to such high temperatures requires extremely high energy inputs. Focusing radiated light requires precise and expensive optical systems, as well. Source material costs can also be extremely high because source material must be delivered continuously to a precise location for being heated by the laser or discharge process. Consequently, obtaining light in the desired wavelengths in quantities that will be useful in commercial applications will require optimization of all system components and source materials.

Prior systems for generating short-wavelength light have not been efficient because, in part, they require radiation substances of high density or inefficient geometries. In such prior systems, the radiating material absorbs laser energy, expands as it reaches the plasma state, and emits radiation in a direction generally back toward the source of the laser beam. At best, radiation is emitted in directions 2π steradians from the front (laser-illuminated) side of the source material.

To avoid problems associated with overly dense radiating materials, lighter density materials have been considered, but such light density materials may not be heated sufficiently because the laser fails to strike an adequate amount of mass to raise the material's temperature.

Further, heating a source material to such high temperatures results in some kinetic energy being transferred to the source material. That kinetic energy results in “ionic debris” that is scattered from the source material. The debris coats or can damage reflecting optics used in the system. Cleaning, replacing, or repairing optical components is expensive and time-consuming and further diminishes overall system efficiencies. It has been taught that debris can be minimized by using a “low density gas” such as H₂ to force debris away from the mirrors. Kooijman 2002, A Laser Plasma EUV Source Based on a Supersonic Xenon Gas Jet Target: Backlighting, Parameter Study and Prepulse Experiments.

In attempts to improve systems efficiencies, various system components have been analyzed. For example, different laser types have been compared and studies have calculated conversion efficiencies using tin planar foil as a source material in laser produced plasmas in a 13.5 nm wavelength for 10.6 μm lasers. The results for pulse widths of approximately 10 to 30 nanoseconds (“ns”) and at lower laser powers (about 4×10⁹ W/cm²) show that CO₂ lasers produce higher conversion efficiencies due to short laser penetration depths into the source material.

In addition, source material geometry and thicknesses have been studied. It has been shown that for a λ_{L}=10.6 μm laser a reduced thickness of a hot emitting layer of source material results in a higher conversion efficiency. For a 10.6 μm laser beam, radiation emitted at λ of about 13.5 nm originates very close to the source material surface and because of this there are less “unconverted” emissions outside of a 2% band. A 2% band is a 2% wide (i.e. approx. 0.27 nm wide) wavelength band, with the center of the band being between approximately 13 nm and 14 nm. Radiation emitted by the radiating material in this band is efficiently reflected off the collector optics. Having less radiation outside the useful band results in less wasted laser energy.

The primary radiating material is typically fed in a stream and into alignment with a laser light using “target injectors.” Previous studies have examined the use of gas jets and liquid jets as target injectors for laser-produced plasma studies. The use of tin-oxide nanoparticles embedded in water droplets has been studied using a λ_{L}=1.06 μm laser to produce EUV radiation. Dual gas jet studies have been performed in which Xe was contained in an inner jet and irradiated with a KrF(λ_{L}=0.25 μm) laser. R. de Bruijn, S. Bartnik, H. Fledderus, H. Fiedorowicz, P. Hegeman, R. Constantinescu, and F. Bijkerk, “Characterization of a Novel Double-Gas Jet Laser-Plasma EUV Source,” Emerging Lithographic Technologies IV, Proc. of SPIE, Vol. 3997 (2000). However, these previous studies have failed to establish the conditions that are required for EUVL sources which have relatively high conversion efficiencies.

Despite numerous studies by sophisticated institutions and knowledgeable scientists, large economic incentives, and a growing need for significant improvements in microchip design and manufacturing techniques, conversion efficiencies remain abysmally low. To date, conversion efficiencies of only 2% to 3% have been demonstrated for lithium LPPs using Li planar targets and laser wavelengths (λ_{L}) of 0.26 and 0.53 μm. C. Rettig, I. Fomenkov, and J. J. MacFarlane, “Computational Predictions of Laser-Produced Plasma EUV Source Performance,” presented at EUV Source Modeling Workshop, Miyazaki, Japan (2004). For tin, CEs of 1% to 4.5% have been reported for LPPs composed of tin and tin-oxide targets. M. Richardson, C. S. Koay, K. Takenoshita, C. Keyser, and M. Al-Rabban, “High Conversion Efficiency Mass-Limited Sn-Based Laser Plasma Source for Extreme Ultraviolet Lithography,” J. Vac. Sci. Technol. B 22, 785 (2004). These efficiencies are inadequate for commercial applications.

Despite efforts to optimize system components and radiation substance materials, efficiencies in prior systems are far from optimal. There are needed short-wavelength radiation apparatus and methods that can produce higher efficiencies with reduced damage and maintenance caused by debris.

### SUMMARY OF THE INVENTION

The present invention is directed to apparatus and methods for overcoming some of the prior art deficiencies.

Applications for the present invention include lithography techniques used to make semiconductor chips, medical research, and other commercial and defense applications. Semiconductor chip manufacturing based on EUV lithography will require bright, efficient radiation sources at wavelengths near 13.5 nm. The present invention will allow chip manufacturers to produce chips with critical dimensions of 32 nm and below, for example. The present invention is directed to high-power and highly efficient radiation sources that impact both the technical and economic viability of EUVL systems. The type of source material (its composition, geometry, and total mass) used in the present invention reduces ionic debris that can potentially damage components of the optics system that reflects and focuses the radiated light. Therefore, the present invention can improve the useful lifetime and robustness of a EUVL system.

In the present invention, laser-produced plasmas (LPPs) and discharge-produced plasmas (DPPs) are heated to temperatures of tens of eV (T approximately 10⁵ to 10⁶ degrees Kelvin) and emit copious amounts of EUV radiation with strong emissions in a narrow wavelength band (Δλ/λ about 2%) near 13.5 nm. An optics system useful with this invention can include Molybdenum-Silicon (Mo—Si) multilayer mirrors for reflecting and focusing light emitted from the source material toward the EUVL tool. Resulting EUVL sources are relatively efficient and stable, and are capable of providing high power levels in the 13.5 nm band (greater than about 110 W of in-band power at a point where they are directed to a EUVL tool, such as lithography tools.

LPP EUVL systems in accordance with the invention operate at repetition rates of about 10 kHz or higher and produce 13.5 nm conversion efficiencies (i.e., the ratio of the in-band 13.5 nm power to the incident laser power on target) of LPP EUVL sources that exceed about 4 to 6 percent.

Indeed, the present invention can achieve even higher conversion efficiencies and reduce shot repetition rate and total power requirements for EUVL laser systems, and therefore can significantly reduce capital, operational, and maintenance costs associated with the system. Reducing the average laser power level requirements by enhancing the conversion efficiency (“CE”) will result in an economically viable platform for manufacturing semiconductor chips, for example. In addition, more efficient source materials used in the present invention reduce laser repetition rate requirements, and thereby reduce the total amount of target debris that can damage the EUVL optics system. As a result of better system efficiencies when using the present invention, it will be possible to develop multiple options for source materials.

Using primary radiating source materials such as those containing tin (Sn) or indium (In), the invention efficiently produces radiation in the short-wavelength band, including extreme ultraviolet wavelengths (approximately 13 nm to 14 nm). Using source materials containing carbon (C) or nitrogen (N), the invention produces radiation in at approximately 3 nm to 4 nm (i.e., in the biological “water window” at 2.3 nm to 4.3 nm where water is effectively transparent) and is also applicable to x-ray microscopes and other medical research instrumentation.

Miniature x-ray sources have a number of potential medical applications, including treatment of: arterial disease, restenosis, and cancer; and for material analysis. NDE x-ray sources can be utilized for inspection of food and industrial products. Laser plasmas and laser-ablation plumes have a variety of applications, including thin film deposition, laser machining, material surface engineering, and cluster and nanotube formulation. In addition, short-pulse lasers can potentially be used in numerous other applications in medicine and industry. Each of the above plasma-based light sources requires pulsed target injector and laser systems, and could benefit significantly from the use of the low-mass radiator sources of the present invention.

The laser system represents a major cost of the source component. By way of example, the laser system cost varies roughly linearly with the required average laser power level, which in turn is inversely proportional to the 13.5 nm conversion efficiency. Therefore, an increase of about 30% in the CE translates into a roughly 30% decrease in the cost of the laser system. Using optimal radiating source materials in the present invention can result in significant cost savings on lasers.

The “primary radiating source” component of an EUVL system (i.e., the portion responsible for producing the required 13.5 nm power levels is also a critical cost component. Several radiating source materials can be used as EUVL radiation sources, including xenon (Xe), tin (Sn), and lithium (Li). The motivation for using these materials is based on their atomic properties. Doubly-ionized lithium (Li²⁺) exhibits strong Ly-α (2p-1s) emission at 13.5 nm. Xenon, at plasma temperatures and densities relevant to EUVL radiation sources, emits radiation near 13.5 nm primarily due to 5p-4d transitions in ionization stages ranging from about Xe⁹⁺ to Xe¹¹⁺. Similarly, tin radiation near 13.5 nm arises from 4f-4d and 4d-4p transitions in ions from about Sn⁶⁺ to Sn¹⁴⁺. For Xe, the dominant radiation emission feature is near 10.5 nm, and the relatively small 13.5 nm feature has contributions from only about three ionization stages. For tin, the dominant emission feature is at 13.5 nm, and has contributions from a wider range of ionization stages.

Materials with high atomic numbers (“high Z”), such as Sn and Xe, tend to emit radiation in unresolved transitions arrays (UTAs) due to the fact that they have many bound electrons and a large number of closely packed atomic energy levels. A single UTA typically emits light in a relatively broad wavelength band, which includes a large number of transitions between two electronic configurations. Indium, having an atomic number (Z=49) that is adjacent to Sn (Z=50), is also a potential 13.5 nm source.

Regardless of source materials selected, using the present invention, source material costs are reduced because less material is wasted, and more radiation is obtained from the source material used.

The present invention also effectively protects the collector mirrors from debris ions emitted by the hot expanding plasma radiation source. The Mo—Si multilayer mirrors are high-cost components of EUVL source systems, and energetic (about several keV) debris ions emanating from the source can cause damage. Longer lifetime of the mirrors and/or fewer expensive cleaning procedures will mean lower operational costs.

To realize the savings and efficiencies described above, the present invention utilizes a primary radiation source material of small size and density, so that radiation is emitted in all directions (nearly 4π steradians). In other words, radiation is emitted from the front (laser-illuminated) side, as well as the back side. The front side radiates in directions up to 2π steradians, and the back side radiates in directions up to an additional 2π steradians. (There are 2π steradians in a hemisphere.) An optics component and method in accordance with the invention gathers and reflects radiation from directions greater than 2π steradians from the source material and focuses the radiated light through an opening toward an end-use tool. The increased quantity of radiated light energy improves system efficiency compared to prior systems that collected light energy from only a portion of the front (laser-illuminated) side of the source material.

A low density gas, composed of low atomic number gas, such as He or H₂, or combinations thereof, can be used to surround the radiation source to confine a flow of primary radiating source material to an area where the energizing laser is focused. The surrounding gas can also reduce the effects of debris ions that could damage the optics system. These debris ions arise from the expanding heated source material and have a relatively high kinetic energy. When used with the present invention, the amount of mass used for the heated material can be extremely small, further reducing the quantity of potential debris ions.

In the present invention, laser pulses and resulting radiation from the material can occur in short bursts (approximately 1 to 100 nanoseconds), and the heating can be repeated at approximately 10 kHz, leading to a pseudo-continuous source of short-wavelength light.

The invention has a relatively high conversion efficiency (“CE”, which for a given laser power, is the amount of short-wavelength light that can be collected and used for an application) because it utilizes more of the source material and collects radiation from nearly 4π steradians or at least, more than 2π steradians. In a preferred embodiment of the present invention, the collector optics nearly surround the source material so that the system can take advantage of light emission in nearly 4π steradians. A preferred optics system is generally shaped as an ellipsoid and may include additional reflectors to reduce the number of energy-depleting reflections that are necessary to focus the light toward an end-use tool.

Utilizing source materials with high 13.5 nm conversion efficiencies relaxes requirements for the average laser power. High-CE sources reduce capital and maintenance costs associated with the laser system, and enhance the EUVL system robustness. In addition, utilizing low mass sources reduces the amount of target debris in the system, thereby reducing potential damage to the EUVL optics system, and increasing the lifetime of optical components.

Computer simulations of laser-produced plasmas (“LPPs”) for tin (Sn) and tin hydride (SnH₄) targets show conversion efficiencies approaching greater than 17% in the present invention compared to current systems that are efficient in the range of about 2% to about 4%. Thus, the present invention has been shown in simulations to achieve vastly improved efficiencies, and reduce the quantity of source materials used. Such an improvement in conversion efficiency can result in this technology being commercially viable.

The present invention is also directed to a high-repetition-rate target injector system capable of establishing the initial conditions required for these low-mass, low-density EUV light sources. (“Initial conditions” refer to the conditions of the source material prior to being irradiated by the laser beam which heats the material to high temperatures.) This can be accomplished using the present invention including: (1) the use of multiple (coaxial) supersonic gas jets, in which an outer jet is used to confine the expansion of the inner gas jet containing an appropriate concentration of Sn (or In) nanoparticles; and (2) the use of liquid jets, in which about 20 μm to 40 μm water droplets of the jet, which have Sn (or In) nanoparticles embedded within them, are irradiated by a low-power laser “pre-pulse” (e.g., a second laser with λ_{L}=1.06 μm), causing the droplets to vaporize and expand to low densities. The expanded low-density source material is then heated to high temperatures by 10.6 μm laser light, resulting in efficient 13.5 nm emission. The present invention is also directed to the use of additional mechanisms to establish the desired initial conditions, such as external or self-generated magnetic fields. For example, by sending a discharge current through the source material, the resulting self-generated magnetic field is used to spatially confine the source in accordance with the present invention.

### BRIEF DESCRIPTION OF THE DRAWINGS

FIG. 1 is a schematic view of a system for obtaining short-wavelength radiation, in accordance with the present invention;

FIG. 2 is a side view of a radiation mirror configuration, in accordance with the present invention;

FIG. 3 is a top view of the radiation mirror configuration of FIG. 2;

FIG. 4 is a schematic view of radiation reflecting off a mirror configuration in accordance with the present invention;

FIG. 5 is a schematic cross-sectional view of a gas jet nozzle in accordance with the present invention;

FIG. 6 is a pre-pulse laser arrangement in accordance with the present invention; and

FIG. 7 is a perspective view of a multiple laser arrangement for use in the present invention.

### DETAILED DESCRIPTION OF THE PREFERRED EMBODIMENTS

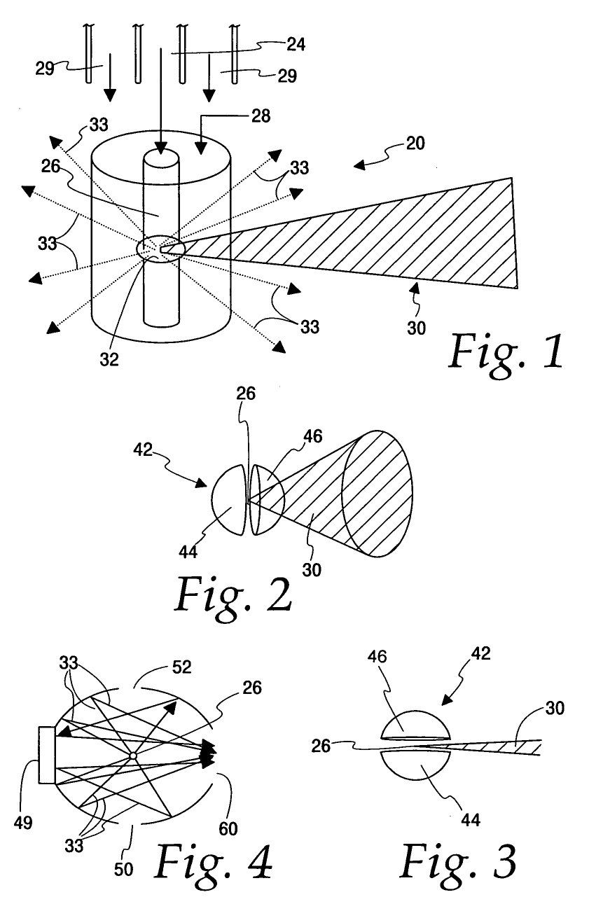

In the following detailed description of the preferred embodiments, the same reference numeral will be used to identify the same item in each of the drawings. As seen in FIG. 1, a system 20 in accordance with the present invention includes a nozzle 24 emitting a continuous source of radiating source material 26, a gas “cocoon” 28 emitted from a nozzle 29, a CO₂ laser beam 30 for heating the radiating material 26 to a temperature where it becomes a plasma 32 radiating light 33 in nearly all directions.

Source materials 26 useful in the present invention are acted upon by laser light 30 or a discharge process or both to radiate short-wavelength light 34. The source material 26 can include a primary radiating material (“hot source material”), and may include a carrier such as a gas of low atomic weight, such as H₂ or He, in which the primary radiating material is embedded. The primary radiating material can also be embedded in water droplets. For lithography applications, typical primary radiating source materials are Sn or SnH₄. Indium (In) is also expected to produce satisfactory results for EUVL.

A preferred source material property in accordance with the present invention relates to the areal mass of the primary radiating material. Areal mass of Sn is designated by ρΔL (integral of density times path length) That areal mass density is preferably in the range of about 10⁻⁶ to about 10⁻⁵, and is more preferably a few times 10⁻⁶ g/cm² while initial density is about 10⁻³ to about 10⁻⁵ g/cm³. In a preferred embodiment of the present invention, a total Sn mass heated per laser pulse is approximately 0.3 nanograms to 25 nanograms per shot.

Preferred laser parameters are from a CO₂ laser with a wavelength “λ_{L}” of about 10.6 μm, pulse width=10 to 50 nanoseconds (square or Gaussian), and laser intensity “I_{L}” of approximately 4×10⁹ W/cm². Using these preferred system parameters, radiation is emitted from both the front (laser-illuminated) side and rear side of plasma 32, thus making the radiator source greater than a 2π emitter and in a preferred embodiment, a nearly 4π steradian emitter.

The thickness of the source material 26 has an effect on the efficiency of the system 20 because, as the thickness of the hot emitting region of (tin) plasma 30 increases, more out-of-band radiation is produced. Out-of-band radiation should be minimized for optimum efficiency and reduced risk of damage to a EUVL tool that uses the radiation. See Chart A below.

In addition to using a carrier gas in which the primary radiating source material is embedded, a preferred embodiment of the present invention uses hydrogen (H₂) or other low atomic number gas or combinations of gases deployed to form the cocoon 28 (FIG. 1) to surround the primary radiating material and trap Sn ions. The trapping occurs because the Sn ions that collide with particles in the cocoon 28, are significantly slowed, and are less able to penetrate through the cocoon 28. Areal density (density times path length) of the cocoon 28 should be low enough to be essentially transparent to both 10.6 μm laser light and 13.5 nm radiation, and yet be high enough to slow or trap Sn ions as a fluid and ions.

Next, FIGS. 2, 3, and 4 illustrate an improved radiator mirror configuration 40 in accordance with the present invention. This arrangement of mirrors takes more complete advantage of radiation from all sides of the primary radiating material as can be obtained from the present invention. As seen in FIG. 4, a dual collector optics arrangement 42 is illustrated, having a first mirror 44 and a second mirror 46, and one additional reflector 49 surrounding the source material 26. In FIGS. 2 and 3, the mirrors 44 and 46 are schematically represented as being nearly hemispherical in shape, yet the ellipsoid shape in FIG. 4 is preferred, as is the use of supplemental reflectors 49 to reduce the number of reflections necessary to deliver the light to a EUVL tool. Illustrated in FIG. 4 are gaps 50 and 52 that are provided for the laser beam 30 to reach the source material 26. Radiation 33 reflects off the first and second mirrors 44 and 46, through an opening 60, and toward the EUVL tool.

In the present invention, the amount of primary radiating material (Sn) used is very small as the source properties are designed to use as little mass as necessary to produce high efficiency. One reason that the present invention achieves such high efficiency is that the primary radiating material radiates light 33 in many directions. To obtain radiation in so many directions, the density of the primary radiating source material must be in an optimum range. The “density” is areal mass and it is defined along an optical path through the Sn and is defined as a line of sight from a point on the mirror through the radiating material. The optical path as seen by mirrors is ρΔL of about 10⁻⁶ g/cm² to 10⁻⁵ g/cm² or more preferably, a few×10⁻⁶ g/cm². Having low density source material prior to being heated by the laser beam (“initial state density”) also helps reduce overall plasma kinetic energy (fluid energy) that reduces the energy of debris; that is, the velocity of the debris ions. Thus, source material density provides two important features: radiation in many directions, including up to 4π steradians, and less debris.

The laser spot size and path should be about 1 mm because a source size that is too large results in portions of the radiation being unusable.

The benefits of small source mass that can be used in the present invention are compared to current systems using spherical droplets of Sn, Xe, or Sn—O with radii of about 10 s of microns. For example, a Sn sphere at ρ=7.3 g/cm³; radius R=50 μm; and M=4 μm results in a mass of about 3,600 grams or about 1,300 kg/year of operation. In the present invention, on the other hand, a Sn sphere at ρ=10⁻³ g/cm³, and areal density (radius) ρΔL=4×10⁻⁶ g/cm² (R=40 μm); M=0.3 nanograms or about 0.3 g/day, which is about 0.1 kg/year of operation, assuming 10 kHz laser pulses per second (“shot rate”).

For a Sn cylinder at ρ=10⁻³ g/cm³, and areal density (radius) ρΔL (sometimes referred to as “ρΔr”)=4×10⁻⁶ g/cm² (R=40 μm) and length=5 mm; results in about 25 ng per shot or about 23 g/day or about 8 kg a year, assuming a 10 kHz shot rate. This is far less than the 1,200 kg/year necessary for current systems.

Preferred source material 26 combinations of Sn and H₂ are in the range of 0.1% to 100% Sn to H₂. For 100% Sn, ρ=10⁻³ g/cm³ with a ΔL of 0.004 cm; for 1% by weight of Sn to H₂, ρ=10⁻⁴ g/cm³ with a ΔL of 0.03 cm; and for 0.1% by weight of Sn to H₂, ρ=10⁻⁵ g/cm³ with a ΔL if 0.2 cm.

As stated above, a further benefit of the present invention is that less laser energy is converted to kinetic energy in debris. Radiation losses occur when laser energy is absorbed by the plasma, converted into kinetic energy (the fluid motion of the plasma), or radiated away from the plasma. The more that is converted into kinetic energy, the less that is available for radiation emission, as the Chart B below illustrates. The portion of laser energy converted into radiation energy increases for lower density targets.

Using an H₂ or He cocoon 28 has been shown in computer simulations to reduce debris energy. Debris can damage or otherwise foul and contaminate mirror and other optical components used in any such system. Minimizing debris, therefore, minimizes damage and maintenance of optical systems. Also, minimizing the kinetic energy of the debris minimizes damages and fouling of optical systems.

Chart C, below, compares simulation results when Sn alone is used, or when Sn is surrounded by He cocoon 28. Chart C shows that when a He cocoon 28 is used with ρ=10⁻⁶ g/cm³, ΔR about 1 cm, the number of ions with energies about 0.1 keV drops significantly with no significant reduction in 13.5 nm power. A cocoon 28 can be set up using a gas jet emitted from a coaxial gas tube having an inner jet emitting Sn mixed with H₂ (or He), and an outer jet of pure He or a combination of gases. The outer jet is the “cocoon” 28. Other jet arrangements are also possible. For example, a jet of primary radiating source material could be at least surrounded by multiple jets emitting the cocoon 28 gases.

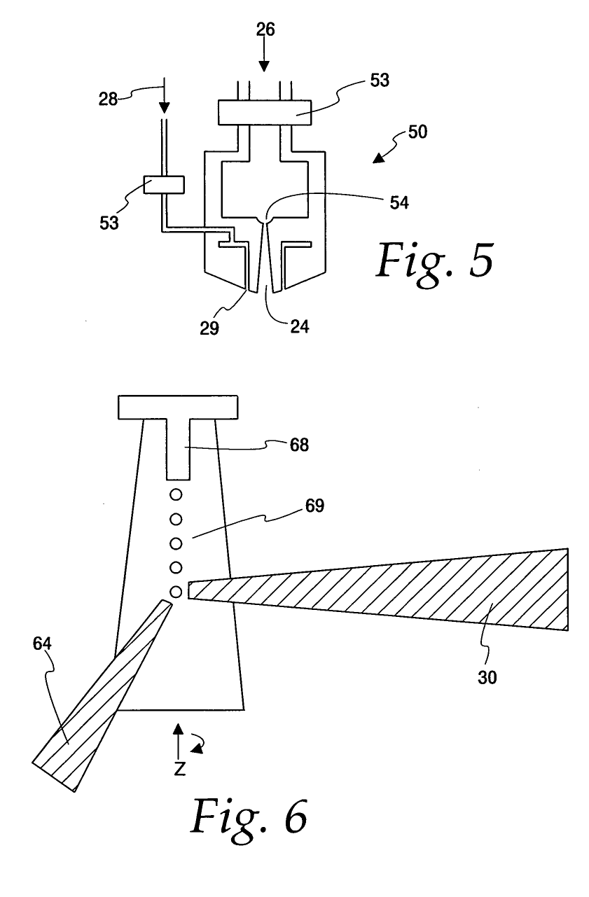

Target delivery systems useful in the present invention will depend on the type of source material 26 being delivered. FIG. 5 shows a schematic illustration for a gas jet nozzle 24 capable of producing an inner supersonic jet (which contains the radiator source material), and a conical H₂ or He jet 29 that can be subsonic or supersonic that provides the debris-mitigating cocoon for the source. Flow of radiating source material 26 and buffer gas 28 is controlled by solenoid valves 53. The supersonic jet 24 is produced using a Laval nozzle. The conditions at the throat 54 and exit of the nozzle (pressure, density, temperature, Mach number) are governed by the cross sectional area at the throat and exit and the isentropic relations for a perfect gas. Mach number jets can be produced using nozzles with small throat diameters (D_{Th}=125 μm). Optimal dimensions are dependent upon the source “target” materials 26 properties, as well as delivery dimensions and flow rates required in each particular application.

Gas jet and moderate-density plasma properties can be measured using a variety of diagnostic techniques, including Mach-Zehnder interferometry, and absorption imaging and spectroscopy.

Further, if a cocoon of buffer gas (as described above) is used to confine the jet of primary radiating material and/or limit the amount and kinetic energy of debris, collector lifetimes would be longer, and the collectors could be closer to the nozzle 24 and the source material 26, which would require less collector surface area and smaller collectors. Such an arrangement would reduce overall system capital and maintenance costs.

Source materials Sn, SnH₄, In, or In compounds can be in the form of: nanoparticles with R about 10 nm to 80 nm; gas jets of SnH₄ small pre-ablated droplets (about 10 μm to 20 μm); or ablation of liquids, foils, or thin wires by a low intensity 1 μm laser, with radial expansion constrained by: an outer coaxial H₂ or He jet or discharge a magnetic field produced by a discharge current. A magnetic field tends to “pinch” a plasma; that is, confine it.

Sn or In nanoparticles (or nanodust) with radii of about 10 nm to 80 nm can be used and are readily produced by laser ablation. A 10 nm radius of Sn, for example, has a mass of 3×10⁻¹⁷ g, and 10⁷ to 10⁹ nanoparticles are used per shot.

The present invention is also directed to a high-repetition-rate target injector system capable of establishing the initial conditions required for these low-mass, low-density EUV light sources. (“Initial conditions” refer to the conditions of the source material prior to being irradiated by the laser beam, which heats the material to high temperatures.) This can be accomplished using the present invention including: (1) the use of multiple (coaxial) gas jets, in which an outer jet is used to confine the expansion of the inner gas jet containing an appropriate concentration of Sn (or In) nanoparticles as seen in FIG. 5; or (2) using the embodiment illustrated in FIG. 6, having liquid jets 68 of small (about 20 μm to 40 μm) droplets 69 emitted and having Sn (or In) nanoparticles embedded within them. The droplets 69 are irradiated by a low-power “pre-pulse” laser 64 (i.e., a second laser with λ_{L}=1.06 μm), causing the droplet to vaporize and expand to low densities.

The expanded low-density source material is then heated to high temperatures by 10.6 μm laser light 30, resulting in efficient 13.5 nm emissions. The present invention is also directed to the use of additional mechanisms to establish the desired initial conditions, such as external or self-generated magnetic fields. For example, by sending a discharge current through the source material, the resulting self-generated magnetic field could be used to spatially confine the source material.

In another alternate embodiment of the present invention, the radiating material may be heated by the absorption of laser light from one or more laser beams. Multiple beams can lead to an increased amount of amount of collectable radiation. This occurs because more of the radiating material continues to be heated by laser beam light as the radiating material expands. Expansion occurs because the hotter portions of the plasma have higher pressure than the cooler surrounding plasma. When multiple beams heat the radiating material, the integrated solid angle of laser light as seen by the radiating material is larger than in the case with one beam. Thus, when the radiating material expands, more of the radiating material continues to be heated by laser light as compared to the case when a smaller number of laser beams is used.

Multiple laser beams can be produced by splitting a single beam using a beam splitter. Alternatively, multiple beams can be produced by multiple laser systems or portions of one or more laser systems.

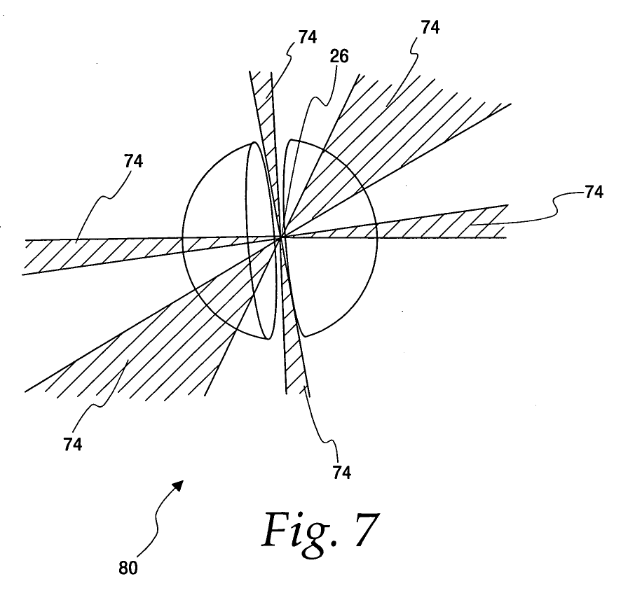

FIG. 7 depicts a system 80 wherein the source material 26 is heated by multiple laser beams 74 (six beams in this example). The source material 26 is irradiated by multiple laser beams 72, and two collector optics components 44 and 46.

Computer simulations and optimization studies of various laser and discharged produced plasma radiation systems such as those referenced above are available through Prism Computational Sciences, Inc., University Research Park, 455 Science Drive, Suite 140, Madison, Wis. 53711

The foregoing detailed description of the preferred embodiments is provided for clearness of understanding only. No unnecessary limitations therefrom should be read into the following claims.

1. Apparatus for producing short-wavelength light by irradiating a primary radiating source material having a front and back side, the apparatus comprising:
a first nozzle for supplying the primary radiating source material to be heated by a laser beam directed to the front side of the primary radiating source material to generate short-wavelength radiation in directions greater than 2π steradians; and
an optics system for reflecting radiation emitted from the primary radiating source material toward a tool.

2. The apparatus of claim 1, and further comprising:
a second nozzle disposed coaxially with the first nozzle, the second nozzle for supplying a buffer gas adjacent to the primary radiating source material.

3. The apparatus of claim 1, and further comprising:
a second nozzle adjacent to the first nozzle, the second nozzle for supplying a buffer gas adjacent to the primary radiating source material.

4. The apparatus of claim 1, wherein the first nozzle supplies nanoparticles of tin as the primary radiating source material.

5. The apparatus of claim 1, wherein the optics system comprises:
a first mirror and second mirror and the first mirror and second mirror are each substantially hemiellipsoidal in shape.

6. A method for obtaining sort-wavelength light from a primary radiating source, the method comprising the steps of:
injecting a primary radiating source material having an areal mass of from about 10⁻⁶ g/cm² to about 10⁻⁵ g/cm² through a first nozzle;
directing a laser beam toward the primary radiating source material to heat and emit short-wavelength light from the primary radiating source material in directions greater than 2π steradians; and
reflecting the short-wavelength light from the primary radiating source material toward a tool.

7. The method of claim 6 and further comprising the step of:
injecting a buffer gas adjacent to the primary radiating source material to reduce kinetic energy of debris from the primary radiating source material.
